(19) United States
(12) Patent Application Publication
(10) Pub. No.: US 2011/0072736 A1
(43) Pub. Date: Mar. 31, 2011

(54) DRAINAGE MEMBERS FOR FLAT ROOFS AND METHODS OF MAKING SAME

(75) Inventors: John Flynn Gullett, Huntington, TX (US); Gregory Joseph Sagorski, Howard City, MI (US); Jeffrey Lynn Glass, Diboll, TX (US); Paul Roberts, Harrisburg, PA (US)

(73) Assignee: Atlas Roofing Corporation, Meridian, MS (US)

(21) Appl. No.: 12/570,135

(22) Filed: Sep. 30, 2009

(51) Int. Cl. E04B 7/22; E04B 7/00; B32B 37/02; B32B 37/14

(52) U.S. Cl. 52/90.2; 52/302.1; 156/78; 52/745.06; 52/745.19; 52/745.13

(57) ABSTRACT

Processes of making slightly sloped roofing members/products (30, 130) for drainage of essentially flat roofs and the products (e.g., sloped roofing members) produced thereby are provided. Some of the processes comprise feeding a series of mold members (50, 150) in a conveyance direction (26) toward a laminator (22) wherein the sloped roofing members are cured. In various embodiments such processes comprise feeding a bottom facer (42) in the conveyance direction toward the laminator (22); depositing a foam-forming mixture (46) on the bottom facer (42); feeding a top facer (44) in the conveyance direction toward the laminator whereby the foam-forming mixture is interposed between the bottom facer (42) and the top facer (44); feeding the series of mold members (50, 150) in the conveyance direction toward the laminator (22) and beneath the bottom facer (44); and curing the foam-forming mixture in the laminator to form a solidified web comprising the sloped roofing member (28, 128). Each of the mold members (50, 150) is configured to impart at least one non-orthogonally sloped surface to a corresponding sloped roofing member.

### BACKGROUND

I. Technical Field

This invention pertains to flat roofs and particularly to sloped coverings which facilitate drainage for a flat roof.

II. Related Art and Other Considerations

The roof of a building is typically oriented or exposed to experience the elements of nature. Such elements include precipitation and moisture. Many buildings have sloped roofs designed to shed precipitation. For reasons such as size or function, other buildings have flat roofs. Flat roofs are often formed of a membrane which extends over the top of the roof. The membrane may be formed with a facer which can be adhered to the membrane. The membrane and/or its facer is/are formulated to have requisite qualities such as water impermeability.

Usually the flat roofs of such buildings are not perfectly flat, but rather have a very gradual slope which leads to one or more drains. For example, the drains can be “internal” drains which are positioned internally on the roof (e.g., toward an interior of the roof rather than at its perimeter).

Unfortunately the internal drains of a flat roof are not always located at the lowest point(s) of the roof deck. For example, structural members may preclude the internal drain(s) from being placed at a location of the lowest point(s). When drains are not optimally placed, water can pond and accumulate in low points of the roof before the water is introduced to the roof drain. The ponding of water on any type of membrane roof system accelerates the aging process of the membrane. For example, membranes exposed to stagnant ponds of water are likely to experience early failure.

Many roofing contractors attempt to facilitate flat roof drainage by forming a “sump” around the roof drain(s). As illustrated by several modes described below, heretofore the fabrication or formation of this sump has occurred primarily at the construction site (e.g., in the field).

One mode of construction-site sump formation is to cut rigid insulation panels around the roof drain into a bowl so that water is directed toward a roof drain. This “bowl sump” can suffer from several problems. For example, the bowl may not be cut large enough to reach the low point of the roof deck (in which case the water ponds in the low point until it reaches the bowl). Another problem is that, in cutting the bowl sump, the contractor may cut off a significant component of the insulation panel. For example, the contractor may cut off a facer from the rigid insulation (which is particularly a problem for adhered membrane systems wherein a facer is adhered to an insulation panel). Yet another problem is that the bowl is often uneven and appears unfinished.

Another mode of construction-site sump formation is to make pre-manufactured, one-way sloped tapered insulation panels at a factory and then attempt to miter cut the panels to form a sump at the construction site. This mode is labor intensive, time consuming, and wasteful (e.g., generates considerable scrap). Moreover, on low-sloped roofs, if the contractor uses a manufactured panel having a thickness less than that of the deck slope, the sump will be ineffective since the water will not be directed towards the roof drain.

A further mode of construction-site sump formation comprises using plural pieces of pre-cut tapered insulation to form a sump around the roof drains. The tapered insulation pieces can be formed of polyisocyanurate, Perlite, HD wood fiber, expanded polystyrene, or extruded polystyrene. Typically four pre-cut pieces of tapered insulation are positioned about the drain. Each piece has an essentially triangular shape, with the apex of the triangle being positioned toward the drain. From its triangle base each piece is sloped toward the apex (e.g., drain). In some installations the four separate pieces of tapered insulation are adhered (e.g., glued) to an underlying substrate. Depending on factors such as the type of insulation material used, the edges of the pieces of tapered insulation can be very delicate and susceptible to breakage, and therefore present challenges not only for installation, but also storage and transportation.

Thus, in general, the processes of forming construction site or “field fabricated” sumps are time consuming, labor intense, and have other deficiencies including those described above.

As a variation of the last above-mentioned mode, a product known as a Vertex brand drain set was fabricated from four pre-cut and pre-tapered polyisocyanurate pieces, and particularly by gluing the four pieces into a “pre-manufactured one piece” drain set. Slope was imparted to each of the four polyisocyanurate pieces by cutting a rectangular board/slab of polyisocyanurate. The “pre-manufactured one piece” drain set could then be transported to the construction site for installation about a drain.

Insulation products can be formed from foam mixtures, such as mixtures which create polyisocyanurate foam, for example. One technique for making a polyisocyanurate foam insulation product comprises depositing (through a set of nozzles) a mixture of foam chemicals in sandwich fashion on a single facer (or between two facers) that is/are being conveyed into and through a laminator machine. The laminator typically comprises moving conveying surfaces or “flights” which not only carry the gestating product through a heating section of the laminator, but which also apply pressure to constrain the rise of the heated foam mixture as the mixture “rises” to form an expanded and hardened board.

Laminators such as that briefly described above have historically been employed for making foam insulation products having essentially orthogonal features. For example, for decades laminators have produced rectangular foam insulation panels with square corners and parallel, flat surfaces. One particular prior art insulation panel was molded to include air or venting channels of rectangular cross section. The insulation panel was not covered with a facer, but instead was placed under another panel which served as a nail base for a roofing material such as shingles. Thus, the un-faced insulation panel was covered by another panel and therefore did not confront weather (e.g., precipitation). This air-vented insulation product was formed by attaching inserts (of rectangular or square cross section) to selected flights of the laminator to thereby impress a pattern of square-edged channel vents into the resultant insulation panel.

It has also been common to provide a sloping edge around portions of a flat roof in order to divert precipitation away from the edge and toward the interior of the flat roof (e.g., toward a sump). Historically such edge members have a right triangular cross section with a hypotenuse directed to divert water to the roof interior. Like the drain sets, the edge members are also covered after installation with a membrane. Typically such edge members have been formed from materials such as wood, and pre-cut to inconvenient lengths.

### BRIEF SUMMARY

In its various aspects the technology disclosed herein concerns processes of making slightly sloped roofing members/products for drainage of essentially flat roofs and the products (e.g., sloped roofing members) produced thereby.

In one of its aspects, the technology disclosed herein concerns processes of making sloped roofing members by feeding a series of mold members in a conveyance direction toward a laminator wherein the sloped roofing members are cured. In various example modes and example embodiments such processes comprise feeding a bottom facer in a conveyance direction toward a laminator; depositing a foam-forming mixture on the bottom facer; feeding a top facer in the conveyance direction toward the laminator whereby the foam-forming mixture is interposed between the bottom facer and the top facer; feeding the series of mold members in the conveyance direction toward the laminator and beneath the bottom facer; and curing the foam-forming mixture in the laminator to form a solidified web comprising the sloped roofing member. Each of the mold members is configured to impart at least one non-orthogonally sloped surface to a corresponding sloped roofing member.

In an example mode of the process and embodiment of product produced thereby, the at least one non-orthogonally sloped surface is an essentially planar sloping surface which extends at least approximately fifty percent across a dimension of the sloped roofing member (e.g., wherein the dimension is a width dimension which is perpendicular to the conveyance direction).

In one example mode of the process and embodiment of product produced thereby, each mold member is configured as a quadrilateral-based pyramid.

In another example mode of the process and embodiment of product produced thereby, each mold member comprises an undulating active mold surface (e.g., configured as a W in a cross section direction), and wherein the cross section direction is perpendicular to the conveyance direction.

In another example mode of the process and embodiment of product produced thereby, each of the mold members is configured to impart a non-orthogonally sloped surface to each of plural sloped roofing members. The process further comprises cutting the solidified web in the conveyance direction to separate the plural corresponding sloped roofing members.

In one of its aspects, the technology disclosed herein concerns processes of making a one-piece drain sump. In various example modes and example embodiments such processes comprise feeding a bottom facer in a conveyance direction toward a laminator; depositing a foam-forming mixture on the bottom facer; feeding a top facer in the conveyance direction toward the laminator whereby the foam-forming mixture is interposed between the bottom facer and the top facer; curing the foam-forming mixture in the laminator to form a solidified web; and, using a mold member while the foam-forming mixture is in the laminator to impart a tapered concave cross sectional shape in two orthogonal dimensions to a segment of the solidified web.

One example mode of the process further comprises feeding the mold member under the bottom facer in the conveyance direction toward the laminator. For example, plural contiguous mold members can be fed in series under the bottom facer in the conveyance direction toward the laminator to form plural segments of the solidified web.

Another example mode of the process further comprises feeding a set of three adjacent mold members under the bottom facer in the conveyance direction toward the laminator, and then feeding a spacer under the bottom facer before feeding another set of three adjacent mold members.

Another example mode of the process further comprises cutting the segment from the web to form a one-piece drain sump insulation panel.

In one example mode of the process and embodiment of product produced thereby, the mold member comprises a shape of a quadrilateral-based pyramid.

Another example mode of the process further comprises using plural nozzles for depositing a corresponding plural streams of the foam-forming mixture on the bottom facer; and selecting positions for the plural nozzles in a lateral direction so that the plural streams of the foam-forming mixture are deposited at locations on the bottom facer whereby, during the curing, the tapered concave shape is imparted in the two orthogonal cross section dimensions to the segment.

In one of its aspects, the technology disclosed herein concerns processes of making a sloped roofing member using a mold member configured to impart plural non-orthogonally sloped surfaces to plural corresponding sloped roofing members. In various example modes and example embodiments such processes comprise feeding a bottom facer in a conveyance direction toward a laminator; depositing a foam-forming mixture on the bottom facer; feeding a top facer in the conveyance direction toward the laminator whereby the foam-forming mixture is interposed between the bottom facer and the top facer; curing the foam-forming mixture in the laminator to form a solidified web; using the mold member while the foam-forming mixture is in the laminator to impart plural non-orthogonally sloped surfaces in a width direction to corresponding plural sloped roofing members; and, thereafter, cutting the solidified web into the plural sloped roofing members. The width direction is orthogonal to the conveyance direction.

In one example mode of the process and embodiment of product produced thereby, a series of mold members are fed in the conveyance direction toward the laminator and beneath the bottom facer.

In one example mode of the process and embodiment of product produced thereby, the mold member comprises an active mold surface configured as a W in the width direction.

In one example mode of the process and embodiment of product produced thereby, the non-orthogonally sloped surface is an essentially planar sloping surface which extends substantially entirely across a dimension of the sloped roofing member.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a diagrammatic side view of an example embodiment of apparatus for making sloped roofing members/products for drainage of essentially flat roofs, and particularly showing fabrication of sump-type sloped roofing members.

FIG. 2 is a top view of a multi-member sump board comprising three sump-type sloped roofing members.

FIG. 3 is a side view of the multi-member sump board of FIG. 2.

FIG. 4 is a side perspective of an example embodiment of a first type of mold member suitable for making sump-type sloped roofing members.

FIG. 5 is a side diagrammatic view of a mold assembly comprising a mold insert base and plural mold members of the first type.

FIG. 6 is a side view showing deposition of a foaming mixture on the mold assembly of FIG. 5 in a feed section of the apparatus of FIG. 1.

FIG. 7 is a sectioned view taken along line 7-7 of FIG. 6.

FIG. 8 is a sectioned view taken along line 8-8 of FIG. 6.

FIG. 9 is a side view showing curing of the foaming mixture on the mold assembly of FIG. 5 in a laminator of the apparatus of FIG. 1.

FIG. 10 is a sectioned view taken along line 10-10 of FIG. 9.

FIG. 11 is a sectioned view taken along line 11-11 of FIG. 9.

FIG. 12 is a side view showing a solidified web formed on the mold assembly of FIG. 5 in a cutting section of the apparatus of FIG. 1.

FIG. 13 is a sectioned view taken along line 13-13 of FIG. 12.

FIG. 14 is a sectioned view taken along line 14-14 of FIG. 12.

FIG. 15 is a side view showing a solidified web after removal of the mold assembly of FIG. 3.

FIG. 16 is a sectioned view taken along line 16-16 of FIG. 15.

FIG. 17 is a sectioned view taken along line 17-17 of FIG. 15.

FIG. 18 is a diagrammatic side view of an example embodiment of apparatus for making sloped roofing members/products for drainage of essentially flat roofs, and particularly showing fabrication of edge strip-type sloped roofing members.

FIG. 19 is a side perspective view of a multi-member edge strip board comprising four edge strip-type sloped roofing members.

FIG. 20 is a side perspective view of an undulating or W-surface shaping mold member suitable for fabricating edge strip-type sloped roofing members.

FIG. 21 is a side view showing deposition of a foaming mixture on the mold assembly of FIG. 20 in a feed section of the apparatus of FIG. 18.

FIG. 22 is a sectioned view taken along line 22-22 of FIG. 21.

FIG. 23 is a side view showing curing of the foaming mixture on the mold assembly of FIG. 20 in a laminator of the apparatus of FIG. 18.

FIG. 24 is a sectioned view taken along line 24-24 of FIG. 23.

FIG. 25 is a side view showing a solidified web formed on the mold assembly of FIG. 20 in a cutting section of the apparatus of FIG. 18.

FIG. 26 is a sectioned view taken along line 26-26 of FIG. 25.

FIG. 27 is a side view showing a solidified web at a mold removal station 186 of the apparatus of FIG. 18.

FIG. 28 is a sectioned view taken along line 28-28 of FIG. 27.

FIG. 29 is a sectioned view taken along line 29-29 of FIG. 27.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In its various aspects the technology disclosed herein concerns processes of making slightly sloped roofing members/products for drainage of essentially flat roofs and the products (e.g., sloped roofing members) produced thereby. Several different types of sloped roofing members/products are described herein, as well as processes and apparatus for making same.

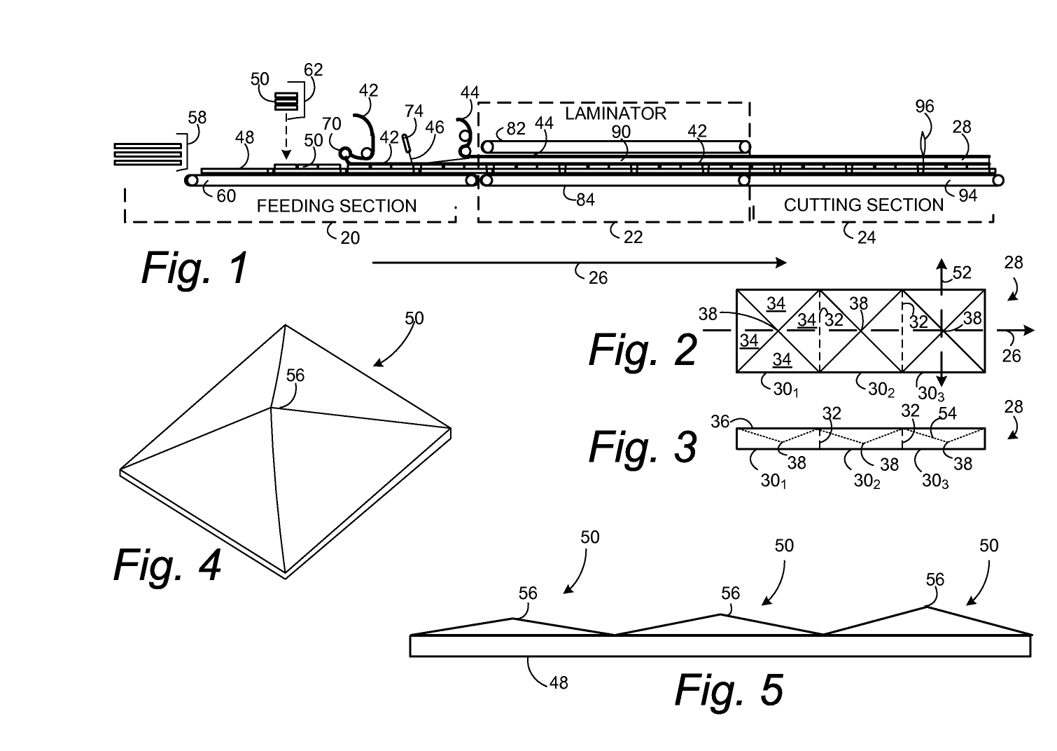

FIG. 1 shows an example embodiment of apparatus for making sloped roofing members/products for drainage of essentially flat roofs, and particularly showing fabrication of sump-type sloped roofing members. The apparatus of FIG. 1 takes the form of an in-line system comprising several sections, including but not limited to feeding section 20; laminating section (laminator 22); and cutting section 24. The feeding section 20, laminator 22, and cutting section 24 are arranged essentially linearly in series in a conveyance direction 26. The apparatus of FIG. 1 serves to form a multi-panel or multi-member sump board 28. In an example embodiment, the multi-member sump board 28 comprises three sump-type sloped roofing members 30 which can be separated from board 28. As understood herein, each sump-type sloped roofing member 30 has a configuration which renders the sump-type sloped roofing member 30 suitable for installation around a drain of an essentially flat roof. In particular, each sump-type sloped roofing member 30 is configured to facilitate water flow/drainage in as many as four directions toward the drain of the flat roof.

An example of a finished version of such a multi-member sump board 28 is shown in FIG. 2. FIG. 2 also shows cut lines 32 at which the multi-member sump board 28 is be cut into three separable sump-type sloped roofing members, particularly sump-type sloped roofing member 30₁, sump-type sloped roofing member 30₂, and sump-type sloped roofing member 30₃. The cutting and separation of the multi-member sump board 28 into its constituent sump-type sloped roofing members 30 can occur downstream in an unillustrated portion of cutting section 24 or off-line as a separate operation. It will be appreciated that, in other embodiments and implementations, the number of sump-type sloped roofing members provided in each multi-member sump board 28 can be any integer. Factors affecting the number of sump-type sloped roofing members provided in each multi-member sump board 28 can include, for example, the relative size of each sump-type sloped roofing member 30 and the speed of operation (e.g., speed of conveyance) of the multi-member sump board 28 in the conveyance direction 26.

To facilitate water flow/drainage in as many as four directions toward the drain of the flat roof, as shown in FIG. 2 and FIG. 3 each sump-type sloped roofing member 30 comprises plural (e.g., four) sloped surfaces 34 which descend from upper edges 36 of each sump-type sloped roofing member 30 to drain trough 38. The drain trough 38 is the lowest point on the upper surface of each sump-type sloped roofing member 30 relative to upper edges 36 thereof, and is preferably essentially centrally located with respect to the sump-type sloped roofing member 30. Thus, the sloped surfaces 34 of sump-type sloped roofing member 30 are essentially planar sloping surfaces which extend at least approximately fifty percent across a dimension of the sloped roofing member. Moreover, the sloped surfaces 34 of sump-type sloped roofing member 30 are non-orthogonally sloping, which means that the sloped surfaces 34 do not connect at right angles (e.g., are not perpendicular) to other surfaces of the sump-type sloped roofing member 30.

It should be kept in mind that the apparatus of FIG. 1 produces the multi-member sump board 28 in essentially inverted form, e.g., in inverted form with respect to the installation orientation shown in FIG. 2 and FIG. 3. That is, after removal from the apparatus of FIG. 1 the multi-member sump board 28 is rotated 180 degrees about the conveyance direction 26 to be turned with drain trough 38 facing upwardly in the manner shown in FIG. 2 and FIG. 3.

Returning now to the apparatus of FIG. 1, the feeding section 20 serves to introduce a sandwiched assembly of materials into laminator 22. The sandwiched assembly includes a bottom mat or bottom facer 42 and a top mat or top facer 44, between which a curable foam mixture 46 is deposited. When introduced into the laminator 22, the sandwiched assembly rides on a mold assembly which serves to impart the desired configuration (including sloped surfaces) of the sump-type sloped roofing member 30. The mold assembly comprises both mold base 48 and one or more mold shaping members (e.g., mold member 50). In order to facilitate subsequent cutting of the resultant multi-member sump boards 28, in an example implementation an unillustrated spacer or separator board can be placed between the mold bases 48. In an example implementation, such spacer extends about 24 inches in the conveyance direction 26. The spacers can serve for providing a window and thus a specific location for cutting the multi-member sump boards 28 and thereby affording appropriate lead and tailing edges of the sump boards.

An example embodiment of a mold member 50 is shown in FIG. 4, while the mold assembly comprising one mold base 48 and three mold members 50 is shown in FIG. 5. In an example implementation, the mold member 50 preferably is configured to impart a tapered concave cross sectional shape in two orthogonal dimensions to a segment of the solidified web, i.e., to impart tapered concave cross sectional shape in two orthogonal dimensions to a sump-type sloped roofing member 30. For example, and as illustrated in FIG. 2, the mold member 50 is configured to impart a tapered concave cross-sectional shape both in the conveyance dimension/direction 26 and in a transverse or width dimension/direction 52. The transverse or width dimension/direction 52 is preferably perpendicular to the conveyance direction 26. FIG. 3 illustrates by broken line 54 an upper surface of the concave cross-sectional shape in the conveyance dimension/direction 26. The surface depicted by broken line 54 thus represents a non-orthogonally sloped surface which is an essentially planar sloping surface which extends at least approximately fifty percent across a dimension of the sloped roofing member 30 (the dimension being the transverse or width dimension/direction 52).

In the example embodiment shown in FIG. 4, mold member 50 is configured as a quadrilateral-based pyramid. As such the quadrilateral-based pyramid of mold member 50 comprises mold apex 56. In an example implementation, mold member 50 is preferably formed from expanded polystyrene foam, and (in an example implementation) can have a density of about three pounds per cubic foot. In an example implementation in which the mold member 50 is shaped as a quadrilateral-based pyramid, each side of the square base has a length of approximately forty eight inches; a perpendicular from the mold apex 56 to the base is approximately one inch. The volume of mold member 50 for such a quadrilateral-based pyramid is then approximately 768 cubic inches. Thus, the cavity formed in each sump-type sloped roofing member 30 (measuring forty eight inches per side) is also approximately 768 cubic inches. In such forty eight inch by forty eight inch embodiments, each sump-type sloped roofing member 30 has a volumetric displacement of approximately 2688 cubic inches, and an average thickness (e.g., height) of 1.167 inch, and a trough depth of about one inch.

As shown in FIG. 5, the mold base 48 is sized as a rectangular parallelepiped and is configured so that three mold members 50 can ride on an upper surface thereof through the apparatus of FIG. 1. It should be appreciated that different sizes of mold bases 48 can be utilized, with each mold base 48 accommodating a greater or lesser number of mold members 50.

As shown in FIG. 1, the mold bases 48 are loaded from base feeding station 58 onto feeding section conveyor 60. The feeding section conveyor 60 conveys each mold base 48 past mold feeding station 62 whereat the plural (e.g., three) mold members 50 are placed (in series and adjacent another) on a top surface of mold base 48. The mold assembly, comprising mold base 48 carrying three mold members 50 (lying end-to-end on the top surface of mold base 48 with mold apexes 56 facing up) are transported by feeding section conveyor 60 under bottom facer feeder 70. The bottom facer feeder 70 comprises a series of overhead rollers which feed bottom facer 42 onto the top (e.g., apex) surfaces of the mold members 50 being transported in the conveyance direction 26 beneath bottom facer feeder 70.

Downstream (in conveyance direction 26) from bottom facer feeder 70 are plural foam nozzles 74 which deposit foam mixture 46 onto an upwardly facing surface of bottom facer 42. In an example embodiment (illustrated, for example in FIG. 11), four such foam nozzles 74 are situated in transverse or width dimension/direction 52 across the apparatus of FIG. 1 for depositing four separate streams of foam mixture 46 onto the upwardly facing surface of bottom facer 42. The positions for the plural nozzles in a lateral direction are selected so that the plural streams of the foam-forming mixture are deposited at locations on the bottom facer whereby, during the curing, the tapered concave shape is imparted in the two orthogonal cross section dimensions to the segment.

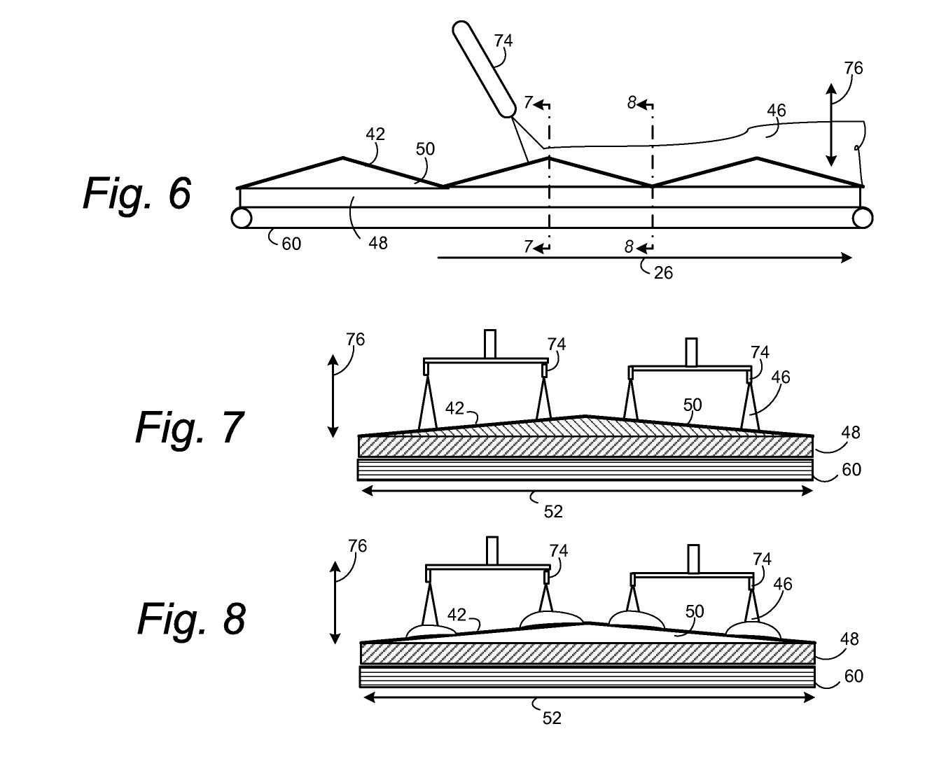

Deposition of the foam mixture 46 is illustrated in enlarged fashion in FIG. 6, together with FIG. 7 and FIG. 8. FIG. 7 particularly shows a cross section of feeding section conveyor 60, the mold assembly, bottom facer 42, and foam mixture 46 deposited thereon at the mold apex 56 of a mold member 50. On the other hand, FIG. 8 shows a cross section of feeding section conveyor 60, the mold assembly, bottom facer 42, and foam mixture 46 deposited thereon at a leading edge of mold member 50.

The foam mixture 46 is a type such as polyisocyanurate which, when activated by a mixture of constituent components, begins to react. In the course of the reaction the foam mixture 46 begins to expand both in the transverse or width dimension/direction 52 across the upward facing surface of bottom facer 42 and in a height direction 76 (the height direction being perpendicular to the transverse or width dimension/direction 52 and the conveyance direction 26).

Top facer feeder 80 is positioned upstream from an entrance to laminator 22. The top facer feeder 80 comprises plural rollers which feed top facer 44 onto the expanding foam mixture 46, thereby completing formation of the sandwiched assembly of materials which is fed into laminator 22.

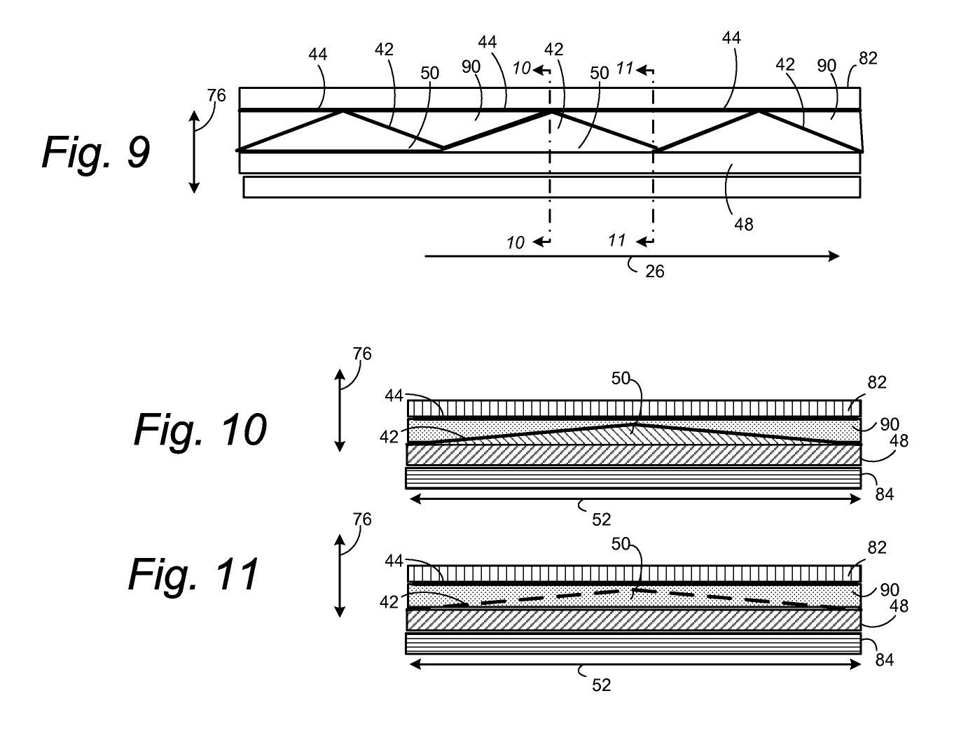

The sandwiched assembly of materials comprising bottom facer 42, the expanding foam mixture 46, and top facer 44 are fed into laminator 22. The laminator 22 can be of any suitable type which forms laminated products comprising a foam mixture, such as a Hennecke brand laminator, for example. The laminator 22 serves to heat and cure the foam mixture 46 so as to form a solidified laminated web. As shown in more detail in FIG. 9, laminator 22 conveys the sandwiched assembly through a heated laminator chamber. In laminator 22 the sandwiched assembly is constrained in the height direction 76 between laminator top flight 82 and laminator bottom flight 84. The laminator top flight 82 and laminator bottom flight 84 also serve to transport the sandwiched assembly through the laminator 22, each of the laminator top flight 82 and laminator bottom flight 84 comprising driven conveyors. An interior chamber the laminator 22 is heated to a sufficiently high temperature to catalyze and/or cure the foam mixture 46, thereby forming cured foam 90. As a result of curing of the foam mixture 46 into cured foam 90, the sandwiched assembly of materials now comprises the cured foam 90 adhered to both bottom facer 42 and top facer 44, thereby forming a solidified web. The solidified web comprises the sloped roofing members 30.

As mentioned above, FIG. 9 illustrated conveyance of the sandwiched assembly through laminator 22. In conjunction with FIG. 9, FIG. 10 shows a cross section of the laminator flights 82 and 84, the mold assembly, and the sandwiched assembly comprising cured foam 90 in cross section at a mold apex 56. On the other hand, FIG. 11 shows a cross section of the laminator flights 82 and 84, the mold assembly, and the sandwiched assembly comprising cured foam 90 at a leading edge of mold member 50.

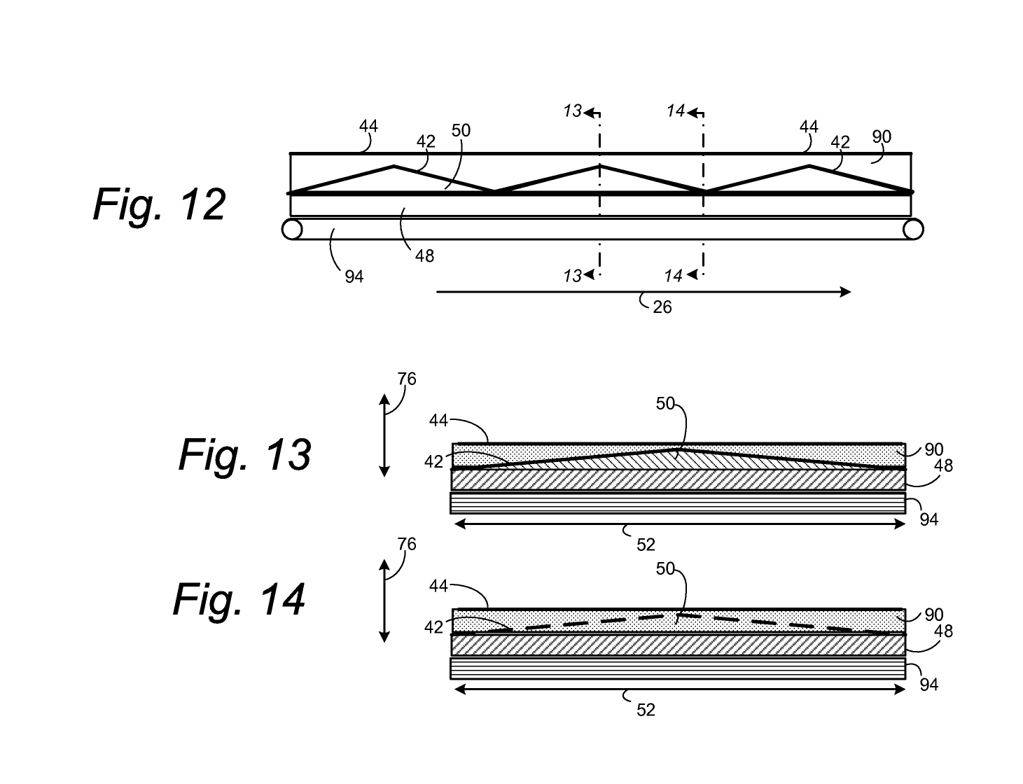

FIG. 12 shows (in enlarged fashion relative to FIG. 1) transport of the sandwiched assembly comprising cured foam 90 in a portion of cutting section 24, e.g., downstream from laminator 22. In particular, FIG. 12 shows the mold assembly and the sandwiched assembly comprising cured foam 90 riding on cutting section conveyor 94. In conjunction with FIG. 12, FIG. 13 shows a cross section of cutting section conveyor 94, the mold assembly, and the sandwiched assembly comprising cured foam 90 in cross section at a mold apex 56. On the other hand, FIG. 14 shows a cross section of cutting section conveyor 94, the mold assembly, and the sandwiched assembly comprising cured foam 90 at a leading edge of mold member 50.

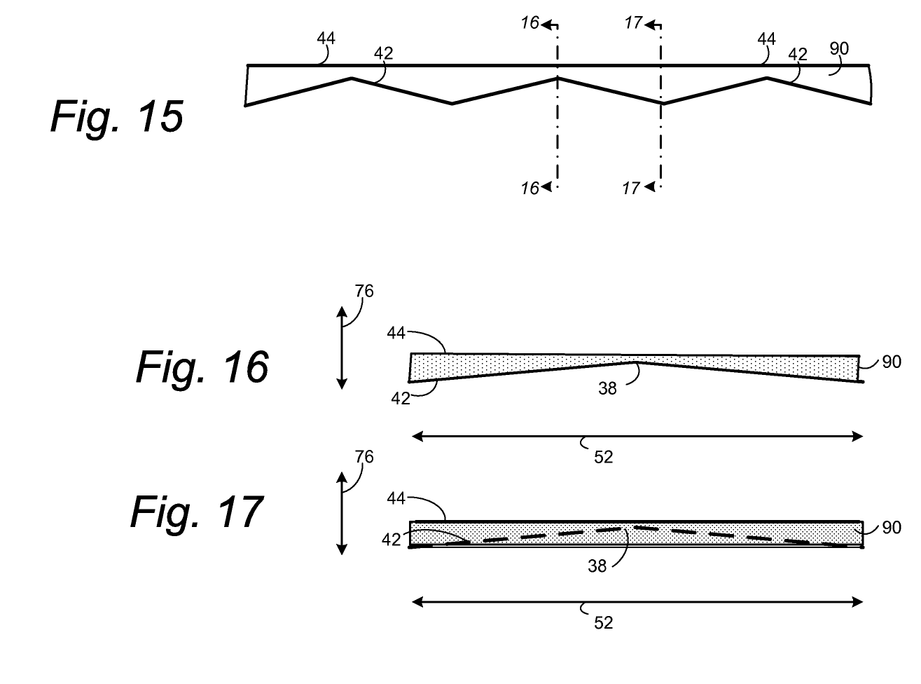

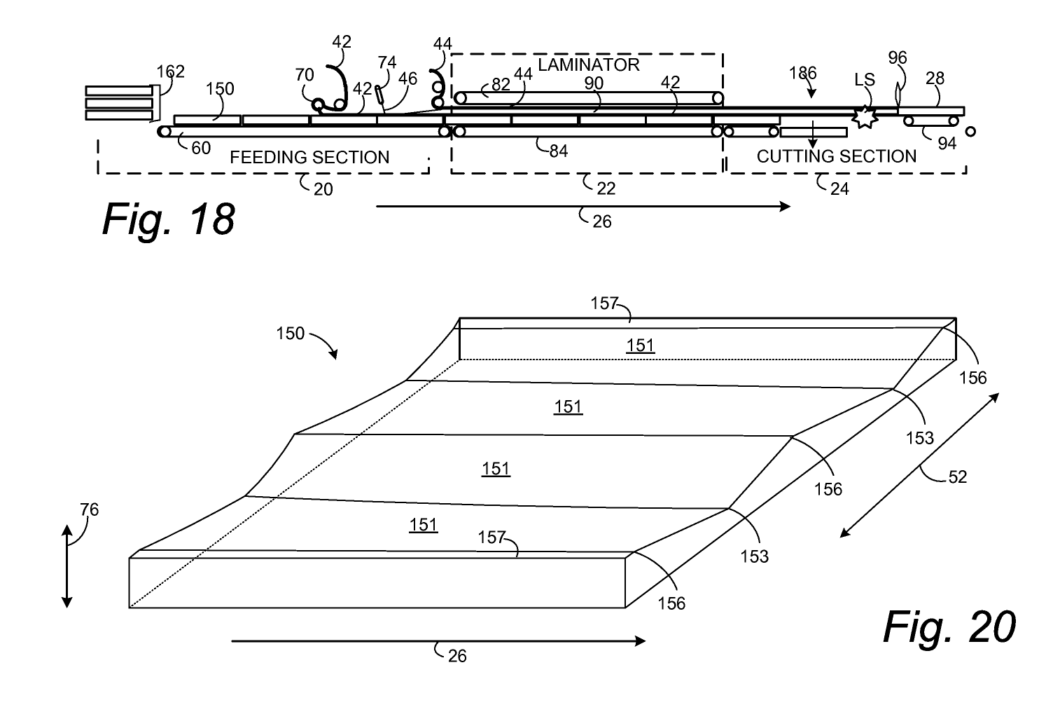

The cutting section 24 comprises cutting station 96 whereat the one-piece multi-member sump board 28 is cut from the solidified segment of web which emerges from laminator 22. Downstream from multi-member sump board 28 the mold assembly is removed, so that the multi-member sump board 28 results with the configuration illustrated in FIG. 15, together with FIG. 16 and FIG. 17. Each of FIG. 15-FIG. 17 show the multi-member sump board 28 as produced by the apparatus of FIG. 1 in its essentially inverted form, e.g., with the drain trough 38 of the multi-member sump board 28 facing downwardly. As such, FIG. 16 shows a cross section of the multi-member sump board 28 at a drain trough 38 of one of the sump-type sloped roofing members 30 of multi-member sump board 28; FIG. 17 shows a cross section of the multi-member sump board 28 at a leading edge of one of the sump-type sloped roofing members 30 of multi-member sump board 28.

Either further downstream in the apparatus of FIG. 1 or off-line in a separate operation the plural sump-type sloped roofing members 30 comprising each multi-member sump board 28 can be separated, e.g. cut away from multi-member sump board 28. Of course, if the cutting station 96 is configured to operate sufficiently quickly relative to the speed of travel in conveyance direction 26, the cutting station 96 can individually cut each sump-type sloped roofing member 30 from the solidified web so that a separate second cutting is not necessary for segmenting the multi-member sump board 28 into its sump-type sloped roofing members 30.

The apparatus of FIG. 1 can also be employed, with a different mold, to make yet other example embodiments of sloped roofing members/products such as edge strip members (edge strips) for drainage of essentially flat roofs. To this end, FIG. 18 illustrates the apparatus of FIG. 1 adapted to use a mold member configured to form a board comprising plural strip members, e.g., a multi-member edge strip board 128. In other words, the mold member used in FIG. 18 serves to impart plural non-orthogonally sloped surfaces in a width direction to corresponding plural sloped (edge strip) roofing members 130 of the multi-member edge strip board 128.

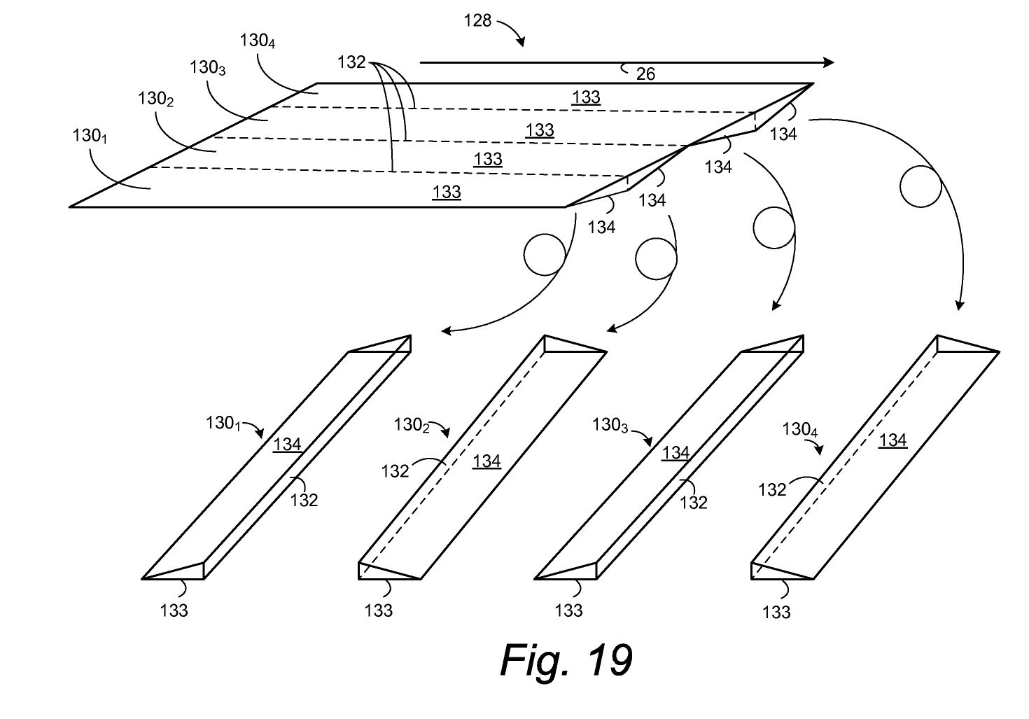

FIG. 19 shows an example of a finished version of such a multi-member edge strip board 128. In the example embodiment of FIG. 19, the multi-member edge strip board 128 comprises four edge strip-type sloped roofing members 130 (e.g., edge strip-type sloped roofing members 130₁-130₄). Each edge strip-type sloped roofing member 130 has a major dimension which extends in parallel to one another and to the conveyance direction 26. As described hereinafter, each edge strip-type sloped roofing member 130 can be separated from multi-member edge strip board 128 along conveyance direction 26. As understood herein, each edge strip-type sloped roofing member 130 has a sloped configuration which renders the edge strip-type sloped roofing member 130 suitable for installation around an edge of an essentially flat roof. In particular, when installed each edge strip-type sloped roofing member 130 is configured to facilitate water flow/drainage in a direction away from an edge a flat roof.

FIG. 19 also shows cut lines 132 at which the multi-member edge strip board 128 is cut into four separable edge strip-type sloped roofing members 130, particularly edge strip-type sloped roofing member 130₁, edge strip-type sloped roofing member 130₂, edge strip-type sloped roofing member 130₃, and edge strip-type sloped roofing member 130₄. Each edge strip-type sloped roofing member 130 has an essentially right triangular cross section. Thus, each edge strip-type sloped roofing member 130 comprises horizontal surface 133; sloped or hypotenuse surface 134; and a vertical leg surface represented by cut line 132.

The apparatus of FIG. 18 produces the multi-member edge strip board 128 in essentially inverted form as shown in the top frame of FIG. 19, e.g., in inverted form with respect to the ultimate installation orientation. That is, after cutting from the multi-member edge strip board 128 and removal from the apparatus of FIG. 18, each edge strip-type sloped roofing member 130 is rotated 180 degrees about the transverse or width dimension/direction 52 so as to be turned with sloped surfaces 134 facing upwardly in the manner shown in the bottom frame of FIG. 19.

It will be appreciated that, in other embodiments and implementations, the number of edge strip-type sloped roofing members provided in each multi-member edge strip board 128 can be any integer. Factors affecting the number of edge strip-type sloped roofing members provided in each multi-member edge strip board 128 can include, for example, the relative size of each edge strip-type sloped roofing member 130 and the width of the apparatus which produces the multi-member edge strip board 128.

To facilitate water flow/drainage in a direction away from an edge the flat roof, as shown in FIG. 19 each edge strip-type sloped roofing member 130 comprises sloped surface 134. The sloped surface 34 of edge strip-type sloped roofing member 130 is an essentially planar sloping surface which extends essentially entirely (and thus at least approximately fifty percent) across a dimension of the sloped roofing member 130. Moreover, the sloped surface 134 of edge strip-type sloped roofing member 130 is non-orthogonally sloping, since that the sloped surface 134 does not connect at right angles (e.g., is not perpendicular) to other surfaces of the edge strip-type sloped roofing member 130.

In one example mode of the process and embodiment of product produced thereby, the multi-member edge strip board is produced using mold member 150 of FIG. 20. The mold member 150 of FIG. 20 comprises an active mold surface configured with a sloped, undulating shape such as a W in the width direction (in transverse or width dimension/direction 52). In particular, the active mold surface comprises mold surface portions 151 which have mold troughs 153 and mold crests or mold apexes 156. In addition, W-surface shaping mold member 150 has a pair of mold side edges 157 which extend entirely along the length of mold troughs 153 in the conveyance direction 26. In an example implementation, the W-surface shaping mold member 150 has a length of 96 inches (plus or minus one inch) along conveyance direction 26; a width of 48 and ⅜ inch+0 inch/−⅛ inch in the transverse or width dimension/direction 52; a measurement of 2 and ½ inch+/− 1/16 inch in the height direction 76 at the mold apexes 156; a measurement of 1 inch+/− 1/16 inch in the height direction 76 at the mold troughs 153; a measurement of twelve inches plus or minus 1/16 inch in the transverse or width dimension/direction 52 from trough to crest (and from crest to trough); and each mold side edges 157 has a measurement of ⅛ inch+/− 1/16 inch in the transverse or width dimension/direction 52.

Returning now to the apparatus of FIG. 18, the feeding section 20 serves to introduce a sandwiched assembly of materials into laminator 22. The sandwiched assembly includes a bottom mat or bottom facer 42 and a top mat or top facer 44, between which a curable foam mixture 46 is deposited. When introduced into the laminator 22, the sandwiched assembly rides on the mold member, e.g., a mold member such as the W-surface shaping mold member 150 of FIG. 20.

As shown in FIG. 18, the mold members 150 are loaded from mold feeding station 162 onto feeding section conveyor 60. The feeding section conveyor 60 conveys each W-surface shaping mold member 150 under bottom facer feeder 70. The bottom facer feeder 70 comprises a series of overhead rollers which feed bottom facer 42 onto the active surfaces 151 of the mold members 150 being transported in the conveyance direction 26 beneath bottom facer feeder 70.

Downstream (in conveyance direction 26) from bottom facer feeder 70 are plural foam nozzles 74 which deposit foam mixture 46 onto an upwardly facing surface of bottom facer 42. In an example embodiment (illustrated, for example in FIG. 22), four such foam nozzles 74 are situated in transverse or width dimension/direction 52 across the apparatus of FIG. 18 for depositing four separate streams of foam mixture 46 onto the upwardly facing surface of bottom facer 42. The positions for the plural nozzles in a lateral direction are selected so that the plural streams of the foam-forming mixture are deposited at locations on the bottom facer whereby, during the curing, an inverse of the W-surface shaping mold is imparted in to the edge strip-type sloped roofing member 130. In an example implementation in which the width of the multi-member edge strip board 128 is four feet in the transverse or width dimension/direction 52 the two nozzles 74 which are closest to the edge of multi-member edge strip board 128 are spaced in transverse or width dimension/direction 52 about five inches from the edge of the multi-member edge strip board 128, and the two nozzles 74 of each commonly fed pair are separated in transverse or width dimension/direction 52 by approximately fourteen inches. By not over packing the foam mixture at edges of the mold, a near zero laminate thickness can be achieved at the edges of multi-member edge strip board 128 which are parallel to the conveyance direction 26.

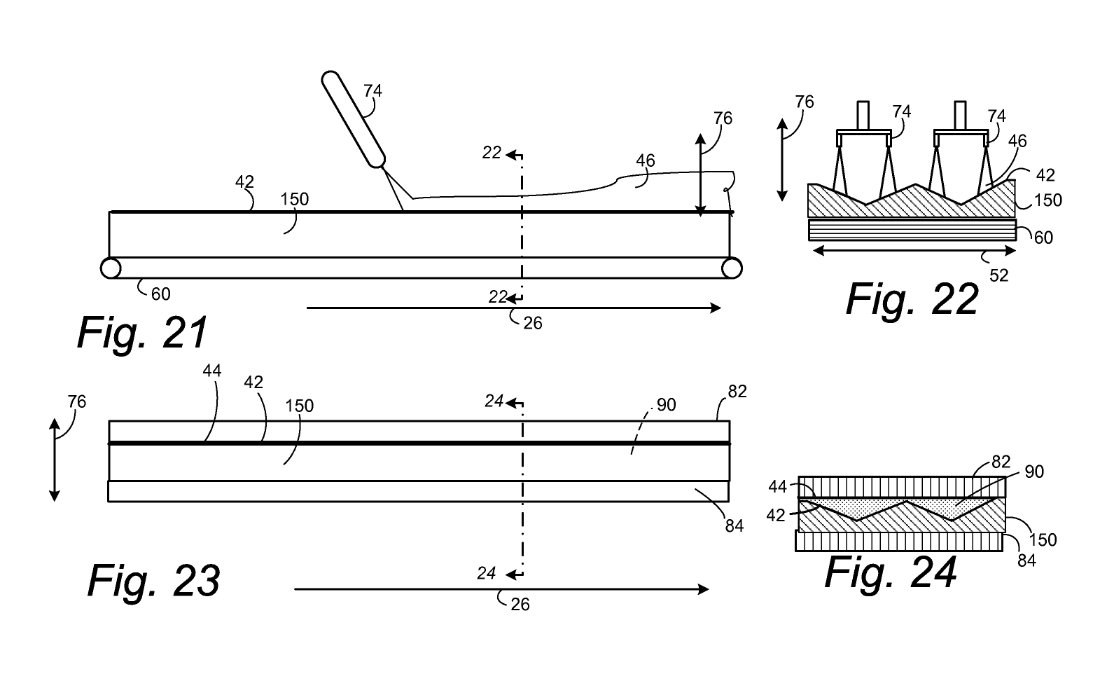

Deposition of the foam mixture 46 is illustrated in enlarged fashion in FIG. 21, together with FIG. 22. FIG. 22 shows a cross section of feeding section conveyor 60, the W-surface shaping mold member 150, bottom facer 42, and foam mixture 46 deposited thereon.

The foam mixture 46 is a type such as polyisocyanurate which, when activate by a mixture of constituent components, begins to react. In the course of the reaction the foam mixture 46 begins to expand both in the transverse or width dimension/direction 52 across the upward facing surface of bottom facer 42 and in a height direction 76 (the height direction being perpendicular to the transverse or width dimension/direction 52 and the conveyance direction 26).

Top facer feeder 80 is positioned upstream from an entrance to laminator 22. The top facer feeder 80 comprises plural rollers which consecutively feed top facer 44 onto the expanding foam mixture 46, thereby completing formation of the sandwiched assembly of materials which is fed into laminator 22.

For producing the edge strip-type sloped roofing member 130, the sandwiched assembly of materials comprising bottom facer 42, the expanding foam mixture 46, and top facer 44 are fed into laminator 22. The laminator 22 serves to heat and cure the foam mixture 46 so as to form a solidified laminated web. As shown in more detail in FIG. 23, laminator 22 conveys the sandwiched assembly through a heated laminator chamber. In laminator 22 the sandwiched assembly is constrained in the height direction 76 between laminator top flight 82 and laminator bottom flight 84. The laminator top flight 82 and laminator bottom flight 84 also serve to transport the sandwiched assembly through the laminator 22. In an example embodiment, each of the laminator top flight 82 and laminator bottom flight 84 comprise driven conveyors. An interior chamber the laminator 22 is heated to a sufficiently high temperature to catalyze and/or cure the foam mixture 46, thereby eventually forming cured foam 90. As a result of curing of the foam mixture 46 into cured foam 90, the sandwiched assembly of materials now comprises the cured foam 90 adhered to both bottom facer 42 and top facer 44, thereby forming a solidified web. The solidified web comprises the multi-member edge strip board 128 and its constituent sloped roofing members 130.

As mentioned above, FIG. 23 illustrates conveyance of the sandwiched assembly through laminator 22. In conjunction with FIG. 23, FIG. 24 shows a cross section of the laminator flights 82 and 84, the W-surface shaping mold member 150, and the sandwiched assembly comprising cured foam 90.

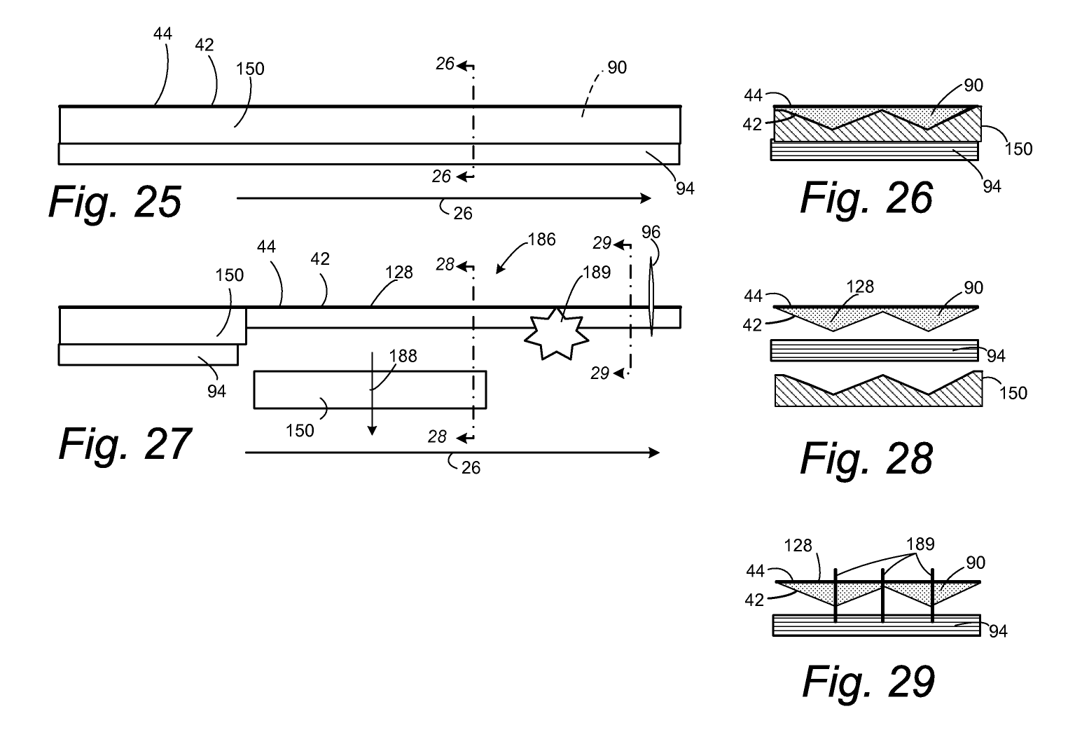

FIG. 25 shows (in enlarged fashion relative to FIG. 18) transport of the sandwiched assembly comprising cured foam 90 in a portion of cutting section 24, e.g., downstream from laminator 22. In particular, FIG. 25 shows the mold assembly and the sandwiched assembly comprising cured foam 90 riding on cutting section conveyor 94. In conjunction with FIG. 25, FIG. 26 shows a cross section of cutting section conveyor 94, the mold assembly, and the sandwiched assembly comprising cured foam 90 for multi-member edge strip board 128.

FIG. 27 shows a certain portion of cutting section 24 known as mold removal station 186. In the mold removal station 186, a portion of the cutting section conveyor 94 which extends in the conveyance direction 26 has a gap sized so that the W-surface shaping mold member 150 can drop below the cutting section conveyor 94 as depicted by arrow 188. As the W-surface shaping mold member 150 drops below the plane of cutting section conveyor 94, the multi-member edge strip board 128 (comprising bottom facer 42, cured foam 90, and top facer 44) continues to travel through cutting section 24 in the conveyance direction 26, but now unsupported by W-surface shaping mold member 150 (see also FIG. 28). Thus, the multi-member edge strip board 128 assumes a conveyance planar altitude which is lower than its laminator planar altitude by an amount substantially equal to the thickness of W-surface shaping mold member 150. The mold member 150 can be removed and returned to mold feeding station 162.

As also shown by FIG. 27 in addition to FIG. 29, downstream from mold removal station 186 is board stripper station. At the board stripper station saws 189 cut multi-member edge strip board 128 into the four longitudinal strips extending in the conveyance direction 26. The saws 189 can be circular saws that revolve about an axis which is parallel to the transverse or width dimension/direction 52, and whose blades extend parallel to the conveyance direction 26. Yet further downstream in the cutting section 24 from the saws 189 is the cutting station 96, whereat the multi-member edge strip board 128 is cut in the transverse or width dimension/direction 52, thus separating four edge strip-type sloped roofing members 130₁-130₄ from the solidified web output from the laminator 22.

The laminator 22 can be of any suitable type which forms laminated products comprising a foam mixture, such as a Hennecke brand laminator, for example. In making the multi-member sump board 28, the laminator 22 is preferably operated at much lower speeds than speeds used to make routine foam insulation boards.

Any suitable mat or facing material can be utilized for the bottom facer 42 and top facer 44 for the embodiments described herein. In an example embodiment the bottom facer 42 and top facer 44 comprise facers made according to technology taught in U.S. Pat. Nos. 6,572,736 and 7,410,553. However, other facing materials, such as coated glass mat and Kraft/Foil laminates (for example) can instead be utilized for one or both of bottom facer 42 and top facer 44.

In the foregoing polyisocyanurate foam mixtures have been mentioned as one example type of foam mixture for use in making sloped roofing members of the differing embodiments described herein. Examples of appropriate polyisocyanurate foam mixtures and/or facers/mats are provided in one or more of the following U.S. Pat. Nos. 5,001,005; 5,102,728; 5,112,678; 5,166,182; 5,252,625; 5,254,600; 5,294,647; 5,342,859; 6,572,736; 6,866,923; 7,138,346, all of which are incorporated herein by reference. Other types of foam forming mixtures are also possible for use in all embodiments of the technology disclosed herein, including (for example) phenol-formaldehyde, urea-formaldehyde, and the like.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A process of making a sloped roofing member for drainage of an essentially flat roof, the process comprising:
feeding a bottom facer in a conveyance direction toward a laminator;
depositing a foam-forming mixture on the bottom facer;
feeding a top facer in the conveyance direction toward the laminator whereby the foam-forming mixture is interposed between the bottom facer and the top facer;
feeding a series of mold members in the conveyance direction toward the laminator and beneath the bottom facer, each of the mold members being configured to impart at least one non-orthogonally sloped surface to a corresponding sloped roofing member;
curing the foam-forming mixture in the laminator to form a solidified web comprising the sloped roofing member.

2. The process of claim 1, wherein the at least one non-orthogonally sloped surface is an essentially planar sloping surface which extends at least approximately fifty percent across a dimension of the sloped roofing member.

3. The process of claim 2, wherein the dimension is a width dimension which is perpendicular to the conveyance direction.

4. The process of claim 1, wherein each mold member is configured as a quadrilateral-based pyramid.

5. The process of claim 1, wherein each mold member comprises an active mold surface configured as a W in a cross section direction, and wherein the cross section direction is perpendicular to the conveyance direction.

6. The process of claim 1, wherein each of the mold members is configured to impart a non-orthogonally sloped surface to each of plural sloped roofing members; and further comprising cutting the solidified web in the conveyance direction to separate the plural corresponding sloped roofing members.

7. A process of making a one-piece drain sump for drainage of an essentially flat roof, the process comprising:
feeding a bottom facer in a conveyance direction toward a laminator;
depositing a foam-forming mixture on the bottom facer;
feeding a top facer in the conveyance direction toward the laminator whereby the foam-forming mixture is interposed between the bottom facer and the top facer;
curing the foam-forming mixture in the laminator to form a solidified web;
using a mold member while the foam-forming mixture is in the laminator to impart a tapered concave cross sectional shape in two orthogonal dimensions to a segment of the solidified web.

8. The process of claim 7, further comprising feeding the mold member under the bottom facer in the conveyance direction toward the laminator.

9. The process of claim 8, further comprising feeding plural contiguous mold members under the bottom facer in the conveyance direction toward the laminator to form plural segments of the solidified web.

10. The process of claim 9, further comprising feeding a set of three adjacent mold members under the bottom facer in the conveyance direction toward the laminator, and then feeding a spacer under the bottom facer before feeding another set of three adjacent mold members.

11. The process of claim 7, further comprising cutting the segment from the web to form a one-piece drain sump insulation panel.

12. The process of claim 7, wherein the mold member comprises a shape of a quadrilateral-based pyramid.

13. The process of claim 7, wherein the quadrilateral-based pyramid is configured to form a cavity in the segment, the cavity having a volume of substantially 768 cubic inches for a segment having a volumetric displacement of approximately 2688 cubic inches.

14. The process of claim 7, further comprising
using plural nozzles for depositing a corresponding plural streams of the foam-forming mixture on the bottom facer; and
selecting positions for the plural nozzles in a lateral direction so that the plural streams of the foam-forming mixture are deposited at locations on the bottom facer whereby, during the curing, the tapered concave shape is imparted in the two orthogonal cross section dimensions to the segment.

15. A process of making a sloped roofing member for drainage of an essentially flat roof, the process comprising:
feeding a bottom facer in a conveyance direction toward a laminator;
depositing a foam-forming mixture on the bottom facer;
feeding a top facer in the conveyance direction toward the laminator whereby the foam-forming mixture is interposed between the bottom facer and the top facer;
curing the foam-forming mixture in the laminator to form a solidified web;
using a mold member while the foam-forming mixture is in the laminator to impart plural non-orthogonally sloped surfaces in a width direction to corresponding plural sloped roofing members, the width direction being orthogonal to the conveyance direction; and thereafter,
cutting the solidified web into the plural sloped roofing members.

16. The process of claim 15, further comprising feeding a series of mold members in the conveyance direction toward the laminator and beneath the bottom facer.

17. The process of claim 15, wherein the mold member comprises an active mold surface configured as a W in the width direction.

18. The process of claim 15, wherein the non-orthogonally sloped surface is an essentially planar sloping surface which extends substantially entirely across a dimension of the sloped roofing member.

19. A sloped roofing product made by the process of claim 1.

20. A sloped roofing product made by the process of claim 2.

21. A sloped roofing product made by the process of claim 4.

22. A sloped roofing product made by the process of claim 5.

23. A sloped roofing product made by the process of claim 7.

24. A sloped roofing product made by the process of claim 8.

25. A sloped roofing product made by the process of claim 9.

26. A sloped roofing product made by the process of claim 12.

27. A sloped roofing product made by the process of claim 15.

28. A sloped roofing product made by the process of claim 16.

29. A sloped roofing product made by the process of claim 17.

30. A sloped roofing product made by the process of claim 18.
